(19) United States
(12) Patent Application Publication
(10) Pub. No.: US 2025/0109354 A1
(43) Pub. Date: Apr. 3, 2025

(54) FABRIC CARE COMPOSITION WITH MALODOR REMOVAL/INHIBITION AGENT

(71) Applicant: Henkel AG & Co. KGaA, Duesseldorf (DE)

(72) Inventors: Daniel Thomas Piorkowski, Fairfield, CT (US); Janet Coope-Epstein, Trumbull, CT (US)

(21) Appl. No.: 18/886,356

(22) Filed: Sep. 16, 2024

Related U.S. Application Data
(60) Provisional application No. 63/586,781, filed on Sep. 29, 2023.

(51) Int. Cl. C11D 3/00; C11D 3/12; C11D 3/20; C11D 3/22; C11D 3/50; C11D 17/06

(52) U.S. Cl. CPC C11D 3/0068; C11D 3/124; C11D 3/2079; C11D 3/222; C11D 3/505; C11D 17/06; C11D 2111/12

(57) ABSTRACT

A composition for fabric treatment (“CFT”) that contains a malodor control agent is provided. The malodor control agent is a highly-branched cyclic dextrin. The CFT is in the form of melt bodies (e.g., pastilles) and can be used during the washing of fabrics to eliminate malodor from the washed fabrics.

### CROSS REFERENCE TO RELATED APPLICATION

The present invention claims the benefit of U.S. Provisional Patent Application No. 63/586,781 filed Sep. 29, 2023, the entire content and disclosure of which is incorporated herein by reference.

### BACKGROUND

The present disclosure generally relates to fabric laundering, and more particularly to a composition for fabric treatment (“CFT”) that contains a malodor control agent and a method of using the same. The CFT of the present disclosure is a melt body such as, for example, a pastillie. In the present disclosure, the terms “composition for fabric treatment,” and “CFT” can be used synonymously with the term “melt body.”

Fabrics (or textiles) can become hard due to repeated washings. Also, even after washing, fabrics can have an undesirable smell. To restore their softness, improve their scent, or impart other desirable properties, fabrics are often treated by additional processes that are separate from their washing. The treatments are separate because the fabric-treating compositions are often not compatible with the washing detergent. These additional processes can be done, for example, in the washer during an added cycle, or in the dryer when using a solid composition, such as a dryer sheet. For example, it is well known to provide liquid fabric conditioning compositions that soften washed fabrics. Such compositions are typically added to the fabrics in the rinse cycle of the wash process.

Body odor is one of the most prevalent malodors that consumers seek to address by laundering with various detergents, and also by using fabric conditioning compositions. The chemical constituents within body odor, predominantly short-chained fatty acids and mercaptans, persist on fabrics post-wear and may sometimes continue to be perceivable after washing with conventional laundry products. It would therefore be desirable to identify new approaches to further neutralize these malodors to provide enhanced benefits.

### SUMMARY

A composition for fabric treatment (“CFT”) that contains a malodor control agent is provided. The malodor control agent is a highly-branched cyclic dextrin. The CFT of the present disclosure is a solid composition that is in the form of melt bodies (e.g., pastilles) and can be used during the washing of fabrics to eliminate malodor from the washed fabrics.

In embodiments of the present disclosure, the CFT comprises (a) from about 20 weight percent to about 95 weight percent of at least one water-soluble carrier selected from an aqueous salt, wherein the aqueous salts have a water vapor partial pressure at a particular temperature in a range of from 30° C. to 100° C. that corresponds to water partial pressure of a saturated solution of the salt; (b) from about 0.05 weight percent to about 5.0 weight of a highly-branched cyclic dextrin; (c) from about 0.1 weight percent to about 20 weight percent at least one fragrance; and (d) from about 0.1 weight percent to about 10 weight percent of at least one buffer system, wherein the weight percent of (a)-(d) is based on a total weight of the composition.

In embodiments of the present disclosure, the CFT consists essentially of components (a)-(c).

In other embodiments of the present disclosure, the CFT consists of components (a)-(c).

In embodiments of the present disclosure, the water-soluble carrier is selected from the group consisting of sodium acetate trihydrate (Na(CH₃COO)·3H₂O), sodium sulfate (Na₂SO₄·10H₂O), trisodium phosphate dodecahydrate (Na₃PO₄·12H₂O) and strontium chloride hexahydrate (SrCl₂·6H₂O), or water free sodium acetate.

In embodiments of the present disclosure, the highly-branched cyclic dextrin has an average molecular weight of about 100 kilo Daltons to about 5000 kilo Daltons.

In embodiments of the present disclosure, the highly-branched cyclic dextrin has an average molecular weight of about 500 kilo Daltons to about 3000 kilo Daltons.

In embodiments of the present disclosure, the highly-branched cyclic dextrin is present in an amount from about 0.1 weight percent to about 1.5 weight percent.

In embodiments of the present disclosure, the highly-branched cyclic dextrin is present in an amount from about 0.1 weight percent to about 1.0 weight percent.

In embodiments of the present disclosure, the highly-branched cyclic dextrin is present in an amount from about 0.15 weight percent to about 0.75 weight percent.

In embodiments of the present disclosure, the highly-branched cyclic dextrin is present in an amount from about 0.15 weight percent to about 0.5 weight percent.

In embodiments of the present disclosure, the highly-branched cyclic dextrin is present in an amount from about 0.15 weight percent to about 0.35 weight percent.

In embodiments of the present disclosure, the fragrance is an ester, an ether, an aldehyde, a ketone, an alcohol, a hydrocarbon, an essential oil, or a combination thereof.

In embodiments of the present disclosure, the buffer system is a solid buffer system selected from the group consisting of sodium hydrogen carbonate, sodium carbonate, disodium hydrogen phosphate, sodium glutamate, sodium aspartate, tris(hydroxymethyl)aminomethane (TRIS), and combinations thereof.

In embodiments of the present disclosure, the composition can further comprise at least one rheology modifier selected from an inorganic rheology modifier, an organic rheology modifier and mixtures thereof, wherein the at least one rheology modifier is present in an amount of from about 0.1 percent by weight to about 25 percent by weight of the composition.

In embodiments of the present disclosure, the inorganic rheology modifier is pyrogenic silica.

In embodiments of the present disclosure, the organic rheology modifier is a microfibrillated cellulose.

In embodiments of the present disclosure, the composition can further comprise an emulsifying substance selected from the group consisting of fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines and combinations thereof.

In embodiments of the present disclosure, the emulsifying substance is present in an amount of from about 0.10 percent by weight to about 10 percent by weight of the composition.

In embodiments of the present disclosure, the composition comprises a plurality of individual particles in the form of melt bodies, wherein: (a) the melt bodies have a particle size between about 0.5 mm and about 10 mm in any spatial direction, (b) the melt bodies have a particle weight of between about 2 mg and about 150 mg, and (c) the melt bodies are solid at temperatures from about 20° C. to about 40° C.

In embodiments of the present disclosure, the melt bodies are in the form of a pastille.

The present disclosure also provides a method of controlling malodors of washed fabrics.

In one embodiment the method includes introducing a composition for fabric treatment (CFT) into a washing apparatus that contains at least one fabric, wherein the composition comprises (a) from about 20 weight percent to about 95 weight percent of at least one water-soluble carrier selected from an aqueous salt, wherein the aqueous salts have a water vapor partial pressure at a particular temperature in a range of from 30° C. to 100° C. that corresponds to water partial pressure of a saturated solution of the salt; (b) from about 0.05 weight percent to about 5.0 weight of a highly-branched cyclic dextrin. (c) from about 0.1 weight percent to about 20 weight percent at least one fragrance; and (d) from about 0.1 weight percent to about 10 weight percent of at least one buffer system, wherein the weight percent of (a)-(d) is based on a total weight of the composition; and washing the at least one fabric in the presence of the composition. The introducing of the CFT can occur anytime during the washing process including at the beginning of the washing process or during a rinse cycle.

In the method embodiment, the composition can be in the form of a plurality of pastilles.

### BRIEF DESCRIPTION OF THE DRAWINGS

FIG. 1 (i.e., the sole drawing FIGURE) is process illustration for the preparation of highly-branched cyclic dextrin from amylose.

### DETAILED DESCRIPTION

The present disclosure will now be described in greater detail by referring to the following discussion and drawings that accompany the present disclosure. In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. As used throughout the present disclosure, the term “about” generally indicates no more than t10%, t5%, ±2%, ±1% or t0.5% from a number. When a range is expressed in the present disclosure as being from one number to another number (e.g., 20 to 40), the present disclose contemplates any numerical value that is within the range (i.e., 22, 24, 26, 28.5, 31, 33.5, 35, 37.7, 39 or 40) or any in amount that is bounded by any of the two values that can be present within the range (e.g., 28.5-35).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this disclosure, specify the presence of stated features, integers, steps, operations, elements, and/or components, but do not preclude the presence or addition of one or more other features, integers, steps, operations, elements, components, and/or groups thereof.

The terms “textile” and “fabric” can be used interchangeably.

The term “fragrance” refers to free fragrances and encapsulated fragrances. The terms “fragrance,” “free fragrance,” “encapsulated fragrance,” and “perfume” can be used interchangeably.

The term “water-soluble” refers to solubility in water at 20° C. of at least 1 g/L, or at least 10 g/L, or at least 50 g/L.

The term “melt” is synonymous with “melt dispersion.” The term “melt” refers to the liquid state of the composition disclosed herein, before it is cooled. The melt and/or melt dispersion is the liquid state of matter of the composition for fabric treatment disclosed herein. Following cooling, the melt becomes a solid composition for fabric treatment.

The term “melt body” is used herein to describe the solid particles than can be obtained from the liquid composition through solidification/shaping when it is cooled. As mentioned above, the terms “composition for fabric treatment,” and “CFT” can be used synonymously with the term “melt body.”

The term “melting temperature” refers to the temperature at which a composition converts from a solid form to a liquid form.

### Composition for Fabric Treatment (“CFT”)

The present disclosure provides a composition for fabric treatment (“CFT”). The CFT is a solid composition that can be used, for example, to treat a textile. The CFT of the present disclosure comprises a plurality of melt bodies. In embodiments, the CFT of the present disclosure comprises pastillies.

The CFT described herein can be used, for example, in the washing cycle of a laundry or fabric cleaning method to provide malodor reduction/elimination to the laundry and/or fabric at any time during the fabric cleaning method, including at the beginning of the fabric cleaning method. The CFT can further provide additional beneficial agents, including, but not limited to a fragrance, to the washed fabrics. A method for treating textiles or fabrics, during which a CFT of the present disclosure is added into a washer containing the textiles or fabrics, is a further subject of this disclosure.

In one aspect, the melt bodies can have a particle size of between about 0.5 mm and about 10 mm, or between about 0.8 mm to about 7 mm, or about 1 mm to about 3 mm in any spatial direction.

In one aspect, the melt bodies can have a particle weight of between about 2 mg and about 150 mg, or between about 4 mg and about 60 mg, or between about 5 mg and about 10 mg.

The melt bodies are desirably solid at room temperature, for example, at about 25° C., and soluble in the usual working temperature ranges of a wash and/or rinse cycle, and can deliver malodor reduction/elimination to fabrics during a wash cycle.

In one aspect, the melt bodies are solid at temperatures from about 20° C. to about 40° C. In one aspect, the melt bodies are solid at temperatures of about 200 C, 25° C., 30° C., 35° C., or 40° C.

In one aspect, the melt bodies are uncoated, coated, waxed, powdered, or a combination thereof.

In one aspect, a method of making the melt bodies comprises: adding a heated water-soluble carrier into water to form a mixture; adding a highly-branched cyclic dextrin, a fragrance and a buffer system into the mixture; and cooling the mixture. In one aspect, the melt is shaped into individual particles comprising melt bodies.

In one aspect, the melt is pressed into a heated inner body and a drum-shaped outer tube which is provided with a large number of holes and which rotates concentrically about the stationary inner body, thereby depositing product drops over the entire width of a continuous cooling belt, preferably a steel belt.

The viscosity (measured by a Texas Instruments AR-G2 Rheometer; plate/plate, 4 cm diameter, 1100 m gap; shear rate 10/1 sec) of the mixture as it leaves the rotating, perforated outer drum is between about 100 mPas and about 1,000 mPas. The viscosity is measured at elevated temperatures, for example at about 70° C.

The drops of the mixture output from the drop former are solidified to form solid melt bodies on the steel belt. The period of time between the mixture being dropped onto the steel belt and the mixture completely solidifying is preferably between about 5 seconds and about 60 seconds.

The solidification of the mixture can be assisted and accelerated by cooling. The drops output onto the steel belt can be cooled either directly or indirectly. Suitable cooling methods include but are not limited to (1) direct cooling with cold air and (2) indirect cooling by cooling the underside of the steel belt by means of cold water.

The melt bodies can be of any desired shape. The shaping takes place before the melt is cooled. Solid, particulate shapes such as substantially spherical, hemispherical, lentil shaped, oblong shaped, figure-like, flake-shaped, cuboid, cylindrical, cone-shaped, spherical-cap-shaped or lens-shaped, hemispherical, disk-shaped or needle-shaped particles are suitable for CTFs of the disclosure. For example, the particles can have a gummy-bear, figure-like design. Melt bodies having a hemispherical shape can advantageously be prepared by means of pastillation.

In one aspect, the melt bodies are uncoated, coated, waxed, powdered, or a combination thereof. Coatings known from the pharmaceutical literature, for example, are suitable as a coating agent. However, the CFTs can also be waxed, i.e., coated in a wax, or powdered with a powdered material, such as a release agent, for protection from caking (agglomeration). In one aspect, the coating does not contain polyethylene glycol (PEG) in a significant amount (>10% by weight based on the coating).

In one aspect, the melt bodies of the present disclosure can be used to deliver malodor reduction/elimination to textiles or fabrics. For example, the CFTs of the present disclosure can be combined with a conventional washing or cleaning composition and brought into contact with the textiles or fabrics, together with a laundry detergent, during the washing cycle of a conventional washing and cleaning process or during hand-washing to deliver malodor reduction/elimination and fragrance to the washed textiles.

Methods for preparing the melt bodies of the present disclosure described in U.S. patent application Ser. No. 16/162,640, which is incorporated by reference herein in its entirety.

In aspect, the CFT of the present disclosure can comprise some or all of the ingredients listed below.

### Highly-Branched Cyclic Dextrin

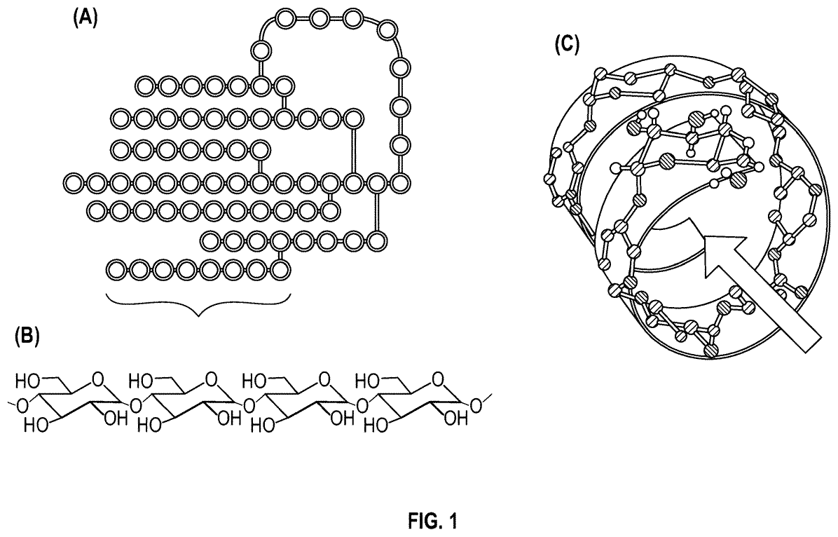

Referring to FIG. 1, dextrin is a polymer of glucose and is produced by a method of enzymatically decomposing a starch, such as amylopectin (for example corn starch). Depending on the enzyme treatment conditions in the manufacturing process, for example, the type and amount of the enzyme, the degree and form of decomposition may be manipulated to produce certain forms, such as branching and molecular weight, of dextrin. Highly-branched cyclic dextrin is one form of dextrin that may be produced in this manner (see portion “A” of FIG. 1), using a cyclization reaction of a branching enzyme (BE,1,4-α-D-glucan: 1,4-α-D-glucan 6-α-D-(1,4-α-D-glucano)-transferase. EC 2.4.1.18). Cyclic dextrin is dextrin characterized in that 6 to 16 glucoses are linked by α-1,4 bonds (see portion “B” of FIG. 1). One example of a cyclic dextrin is α-cyclodextrin, which contains six glucoses. In another example, β-cyclodextrin contains seven glucoses, and in another example, γ-cyclodextrin contains eight glucoses. Without being bound by any theory, the cyclic dextrin can be in the shape of a coil or a helical structure (see portion “C” of FIG. 1). Commercially available highly-branched cyclic dextrin is in the form of a white powder, is soluble in water, and has a loss on drying of less than about 5.5%. In embodiments of the present application, the highly-branched cyclic dextrin is maltodextrin.

The bonds between the glucoses allow cyclic dextrin to have the coil-like structure or helical-like shown in FIG. 1, containing a certain volume of void space. The array of each interior space is formed by oxygen atoms that form glycoside bridges with hydrogen atoms. Therefore, the inner surface becomes very hydrophobic, and the specific shape and physico-chemical properties of the voids have structural features capable of absorbing organic molecules or portions of organic molecules that match the shape of the inner space of the cyclic dextrin. The outside of the cyclic dextrin, however, remains hydrophilic. In this manner, malodors may be entrained within the voids, and effectively removed from the fabric during a drying cycle. Additionally, in the same manner, malodors may be inhibited in fabrics post-wear. In the present disclosure, the highly-branched cyclic dextrin that is used as a fabric malodor removal/inhibition agent can be referred to as cluster dextrin.

The highly-branched cyclic dextrin compounds (i.e., cluster dextrin) employed as a fabric malodor removal/inhibition agent of the CFT of the present disclosure can have an average molecular weight, in embodiments, from about 100 kilo Daltons to about 5000 kilo Daltons, for example from about 500 kilo Daltons to about 3000 kilo Daltons.

In the present disclosure, the highly-branched cyclic dextrin can be included within the CFT of the present disclosure in an amount of from about 0.05 weight percent to about 5.0 weight percent, for example, from about 0.1 weight percent to about 2.5 weight percent, or from about 0.15 weight percent to about 1.5 weight percent.

In certain embodiments, the highly-branched cyclic dextrin can be included within the CFT of the present disclosure in an amount of from about 0.1 weight percent to about 1.5 weight percent, or in an amount from about 0.1 weight percent to about 1.0 weight percent, or in an amount from about 0.15 weight percent to about 0.75 weight percent, or in an amount from about 0.15 weight percent to about 0.5 weight percent, or in an amount from about 0.15 weight percent to about 0.35 weight percent. All weight percentages used herein are by total weight of the CFT, unless otherwise specifically noted.

### Water Soluble Carrier(s)

In one aspect, the CFT of the present disclosure can include a water-soluble carrier that is an aqueous salt wherein the water vapor partial pressure at a temperature of from about 30° C. to about 100° C., or usual working temperature ranges in a wash and/or rinse cycle, corresponds to the water (H₂O) partial pressure of the saturated solution of the salt. The water-soluble carriers of the present disclosure demonstrate this behavior at a temperature of from about 30° C. to about 100° C., or from about 40° C. to about 90° C., or from about 50° C. and about 85° C., or from about 55° C. and about 80° C.

The water-soluble carrier material is selected from aqueous salts of which the water vapor partial pressure at a temperature in the range of from 30° C. to 100° C. corresponds to the H₂O partial pressure of the saturated solution of said salt at that temperature. This leads to the corresponding aqueous salt, also referred to herein as a “hydrate,” dissolving in the water of crystallization thereof when said temperature is reached or exceeded and thus transitioning from a solid to a liquid state of matter. In a formulation for melt bodies, an aqueous salt (hydrate) as a carrier material of which the water vapor partial pressure at a particular temperature in the range of from 30° C. to 100° C. corresponds to the H₂O partial pressure of the saturated solution of said salt at said temperature such that the salt dissolves in the water of crystallization thereof at said temperature, which is a process that can be phenomenologically described as melting, but is in fact a dissolution process, thermodynamically speaking. The water soluble carrier is described in U.S. patent application Ser. No. 16/162,640, which is incorporated by reference herein in its entirety.

In one aspect, the CFT of the present disclosure can include a water soluble carrier. In one aspect, the water-soluble carrier can be an aqueous salt. In one aspect, the water-soluble carrier can be sodium acetate or a hydrate thereof. In one aspect, water-soluble carrier can be water free sodium acetate. In one aspect, the water-soluble carrier can be sodium acetate trihydrate (Na(CH₃COO)·3H₂O), sodium sulfate (Na₂SO₄·10H₂O), trisodium phosphate dodecahydrate (Na₃PO₄·12H₂O) and strontium chloride hexahydrate (SrCl₂·6H₂O).

In one embodiment, the water-soluble carrier is sodium acetate trihydrate (Na(CH₃COO)·3H₂O). In another embodiment, the water-soluble carrier is water-free sodium acetate. In yet a further embodiment, the water-free sodium acetate is used in combination with free water. In one aspect, sodium acetate trihydrate can form in-situ when water-free sodium acetate is used in combination with free water. In such aspects, the water can be used in a sub-stoichiometric or hyper-stoichiometric amount based on the amount that is necessary to convert all of the sodium acetate into sodium acetate trihydrate, for example, in an amount of at least about 60% by weight, or at least about 70% by weight, or at least about 80% by weight, or at least about 90% by weight, or at about 100% by weight, or more, based on the weight of the CFT, which is the amount that is theoretically necessary to convert all of the sodium acetate into sodium acetate trihydrate (Na(CH₃COO)·3H₂O).

In one aspect, the CFT comprises water in a hyper-stoichiometric amount. Accordingly, if one aspect in which water-free sodium acetate is used in isolation, or in combination with a hydrate thereof, the trihydrate water is also used, the amount of water corresponding to at least the amount that would be stoichiometrically necessary to ensure that at least about 60% by weight of the total amount of sodium acetate and the hydrates thereof, preferably about 70% by weight, or at least about 80% by weight, or at least about 90% by weight, or at least about 100% by weight, based on the weight of the CFT, is in the form of sodium acetate trihydrate. In one aspect, the amount of water exceeds the amount that would be theoretically necessary to convert all of the sodium acetate into the corresponding trihydrate. This means, for example, that a composition that contains 50% by weight water-free sodium acetate and no hydrate thereof contains at least 19.8% by weight water (60% of 33% by weight that would be theoretically necessary to convert all of the sodium acetate into sodium acetate trihydrate.

In one aspect, the water soluble carrier can be present in an amount of from about 10% by weight to about 95% by weight, or from about 10% by weight to about 90% by weight, or from about 10% by weight to about 85% by weight, or from about 10% by weight to about 80% by weight, or from about 10% by weight to about 75% by weight, or from about 10% by weight to about 70% by weight, or from about 10% by weight to about 60% by weight, or from about 20% by weight to about 95% by weight, or from about 25% by weight to about 95% by weight, or from about 30% by weight to about 95% by weight, or from about 35% by weight to about 95% by weight, or from about 40% by weight to about 90% by weight, or from about 45% by weight to about 90% by weight of the CFT.

### Fragrance(s) or Perfume(s)

In one aspect, the CFT of the present disclosure comprises at least one fragrance. In one aspect, the fragrance has a melting point that is in the range of from about −100° C. to about 100° C., or from about −80° C. to 80° C., or from about −20° C. to about 50° C., or from about −30° C. to about 20° C. In one aspect, the CFT comprises a fragrance having a melting point that is in the range of from about 25° C. to about 400° C., or from about 50° C. to about 380° C., or from about 75° C. to about 350° C., or from about 100° C. to about 330° C.

In one aspect, the fragrance can be an ester, an ether, an aldehyde, a ketone, an alcohol, a hydrocarbon, an essential oil, and a combination thereof.

In one aspect, the fragrance can be, for example, adoxal (2,6,10-trimethyl-9-undecenal), anisaldehyde (4-methoxybenzaldehyde), cymal (3-(4-isopropyl-phenyl)-2-methylpropanal), ethylvanillin, florhydral (3-(3-isopropylphenyl)butanal), helional (3-(3,4-methylenedioxyphenyl)-2-methylpropanal), heliotropin, hydroxycitronellal, lauraldehyde, lyral (3- and 4-(4-hydroxy-4-methylpentyl)-3-cyclohexene-1-carboxaldehyde), methyl nonyl acetaldehyde, lilial (3-(4-tert-butylphenyl)-2-methylpropanal), phenyl acetaldehyde, undecylenaldehyde, vanillin, 2,6,10-trimethyl-9-undecenal, 3-dodecen-1-al, α-n-amylcinnamaldehyde, melonal (2,6-dimethyl-5-heptenal), 2,4-dimethyl-3-cyclohexene-1-carboxaldehyde (triplal), 4-methoxybenzaldehyde, benzaldehyde, 3-(4-tert-butylphenyl)propanal, 2-methyl-3-(para-methoxyphenyl)propanal, 2-methyl-4-(2,6,6-timethyl-2(1)-cyclohexen-1-yl)butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzylaldehyde, 1,2,3,4,5,6,7,8-octahydro-8,8-dimethyl-2-naphthaldehyde, 2,4-dimethyl-3-cyclohexene-1-carboxaldehyde, 2-methyl-3-(isopropylphenyl)propanal, 1-decanal, 2,6-dimethyl-5-heptenal, 4-(tricyclo[5.2.1.0(2,6)]decylidene-8)butanal, octahydro-4,7-methano-1H-indenecarboxaldehyde, 3-ethoxy-4-hydroxybenzaldehyde, para-ethyl-α,α-dimethylhydrocinnamaldehyde, α-methyl-3,4-(methylenedioxy)hydrocinnamaldehyde, 3,4-methylenedioxybenzaldehyde, α-n-hexylcinnamaldehyde, m-cymene-7-carboxaldehyde, α-methyl phenylacetaldehyde, 7-hydroxy-3,7-dimethyloctanal, undecanal, 2,4,6-trimethyl-3-cyclohexene-1-carboxaldehyde, 4-(3)(4-methyl-3-pentenyl)-3-cyclohexenecarboxaldehyde, 1-dodecanal, 2,4-dimethylcyclohexene-3-carboxaldehyde, 4-(4-hydroxy-4-methylpentyl)-3-cylohexene-1-carboxaldehyde, 7-methoxy-3,7-dimethyloctan-1-al, 2-methylundecanal, 2-methyldecanal, 1-nonanal, 1-octanal, 2,6,10-trimethyl-5,9-undecadienal, 2-methyl-3-(4-tert-butyl)propanal, dihydrocinnamaldehyde, 1-methyl-4-(4-methyl-3-pentenyl)-3-cyclohexene-1-carboxaldehyde, 5- or 6-methoxyhexahydro-4,7-methanoindane-1- or -2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3J-dimethyloctanal, trans-4-decenal, 2,6-nonadienal, para-tolylacetaldehyde, 4-methylphenylacetaldehyde, 2-methyl-4-(2,6,6-trimethyl-1-cyclohexen-1-yl)-2-butenal, ortho-methoxycinnamaldehyde, 3,5,6-trimethyl-3-cyclohexene-carboxaldehyde, 3J-dimethyl-2-methylene-6-octenal, phenoxyacetaldehyde, 5,9-dimethyl-4,8-decadienal, peony aldehyde (6,10-dimethyl-3-oxa-5,9-undecadien-1-al), hexahydro-4,7-methanoindane-1-carboxaldehyde, 2-methyloctanal, α-methyl-4-(1-methylethyl)benzene acetaldehyde, 6,6-dimethyl-2-norpinene-2-propionaldehyde, para-methylphenoxyacetaldehyde, 2-methyl-3-phenyl-2-propen-1-al, 3,5,5-trimethylhexanal, hexahydro-8,8-dimethyl-2-naphthaldehyde, 3-propyl-bicyclo-[2.2.1]-hept-5-ene-2-carbaldehyde, 9-decenal, 3-methyl-5-phenyl-1-pentanal, methyl nonyl acetaldehyde, hexanal and trans-2-hexenal.

In one aspect, the fragrance can be, for example, methyl β-naphthyl ketone, musk indanone (1,2,3,5,6,7-hexahydro-1,1,2,3,3-pentamethyl-4H-inden-4-one), tonalide (6-acetyl-1,1,2,4,4,7-hexamethyltetralin), α-damascone, β-damascone, Δ-damascone, iso-damascone, damascenone, methyl dihydrojasmonate, menthone, carvone, camphor, koavone (3,4,5,6,6-pentamethylhept-3-en-2-one), fenchone, α-ionone, β-ionone, γ-methyl ionone, fleuramone (2-heptylcyclopentanone), dihydrojasmone, cis-jasmone, Iso E Super (1-(1,2,3,4,5,6J,8-octahydro-2,3,8,8-tetramethyl-2-naphthalenyl)ethan-1-one (and isomers)), methyl cedrenyl ketone, acetophenone, methyl acetophenone, para-methoxyacetophenone, methyl β-naphtyl ketone, benzyl acetone, benzophenone, para-hydroxyphenylbutanone, celery ketone (3-methyl-5-propyl-2-cyclohexenone), 6-isopropyldecahydro-2-naphtone, dimethyl octenone, frescomenthe (2-butan-2-ylcyclohexan-1-one), 4-(1-ethoxyvinyl)-3,3,5,5-tetramethylcyclohexanone, methyl heptenone, 2-(2-(4-methyl-3-cyclohexen-1-yl)propyl)cyclopentanone, 1-(p-menthen-6(2)yl)-1-propanone, 4-(4-hydroxy-3-methoxyphenyl)-2-butanone, 2-acetyl-3,3-dimethylnorbomane, 6,7-dihydro-1,1,2,3,3-pentamethyl-4(5H)indanone, 4-damascol, dulcinyl(4-(1,3-benzodioxol-5-yl)butan-2-one), Hexalon (1-(2,6,6-trimethyl-2-cyclohexen-1-yl)-1,6-heptadien-3-one), isocyclemone E (2-acetonaphthone-1,2,3,4,5,6,7,8-octahydro-2,3,8,8-tetramethyl), methyl nonyl ketone, methyl cyclocitrone, methyl lavender ketone, orivone (4-tert-amylcyclohexanone), 4-tert-butylcyclohexanone, delphone (2-pentyl cyclopentanone), muscone (CAS 541-91-3), neobutenone (1-(5,5-dimethyl-1-cyclohexenyl)pent-4-en-1-one), plicatone (CAS 41724-19-0), veloutone (2,2,5-trimethyl-5-pentylcyclopentan-1-one), 2,4,4,7-tetramethyloct-6-en-3-one and tetrameran (6,10-dimethylundecen-2-one).

In one aspect, the fragrance can comprise, for example, 10-undecen-1-ol, 2,6-dimethylheptan-2-ol, 2-methylbutanol, 2-methylpentanol, 2-phenoxyethanol, 2-phenylpropanol, 2-tert-butylcyclohexanol, 3,5,5-trimethylcyclohexanol, 3-hexanol, 3-methyl-5-phenylpentanol, 3-octanol, 3-phenylpropanol, 4-heptenol, 4-isopropylcyclohexanol,4-tert-butylcyclohexanol, 6,8-dimethyl-2-nonanol, 6-nonen-1-ol, 9-decen-1-ol, α-methylbenzyl alcohol, α-terpineol, amyl salicylate, benzyl alcohol, benzyl salicylate, 8-terpineol, butyl salicylate, citronellol, cyclohexyl salicylate, decanol, dihydromyrcenol, dimethyl benzyl carbinol, dimethyl heptanol, dimethyl octanol, ethyl salicylate, ethyl vanillin, eugenol, farnesol, geraniol, heptanol, hexyl salicylate, isoborneol, isoeugenol, isopulegol, linalool, menthol, myrtenol, n-hexanol, nerol, nonanol, octanol, p-menthan-7-ol, phenylethyl alcohol, phenol, phenyl salicylat, tetrahydrogeraniol, tetrahydrolinalool, thymol, trans-2-cis-6-nonadicnol, trans-2-nonen-1-ol, trans-2-octenol, undecanol, vanillin, champiniol, hexenol and cinnamyl alcohol.

In one aspect, the fragrance can be, for example, benzyl acetate, phenoxyethyl isobutyrate, p-tert-butylcyclohexyl acetate, linalyl acetate, dimethyl benzyl carbinyl acetate (DMBCA), phenyl ethyl acetate, benzyl acetate, ethylmethylphenyl glycinate, allyl cyclohexyl propionate, styralyl propionate, benzyl salicylate, cyclohexyl salicylate, floramat, melusat and jasmacyclat.

In one aspect, the fragrance can be, for example, benzyl ethyl ether and ambroxan. The hydrocarbons include mainly terpenes, such as limonene and pinene.

In one aspect, the fragrance can be a mixture of various fragrances, which can be referred to as a perfume or perfume oil. Perfume oils of this kind can also contain natural fragrance mixtures, as are obtainable from plant sources.

In one aspect, the fragrance can be, for example, essential oils such as angelica root oil, anise oil, arnica blossom oil, basil oil, bay oil, champaca blossom oil, citrus oil, silver fir oil, silver fir cone oil, elemi oil, eucalyptus oil, fennel oil, pine needle oil, galbanum oil, geranium oil, ginger grass oil, guaiac wood oil, gurjun balsam oil, helichrysum oil, ho oil, ginger oil, iris oil, jasmine oil, cajeput oil, calamus oil, chamomile oil, camphor oil, canaga oil, cardamom oil, cassia oil, pine needle oil, copaiba balsam oil, coriander oil, spearmint oil, caraway oil, cumin oil, labdanum oil, lavender oil, lemongrass oil, lime blossom oil, lime oil, mandarin oil, balm oil, mint oil, musk seed oil, muscatel oil, myrrh oil, clove oil, neroli oil, niaouli oil, olibanum oil, orange blossom oil, orange oil, origanum oil, palmarosa oil, patchouli oil, peru balsam oil, petitgrain oil, pepper oil, peppermint oil, pimento oil, pine oil, rose oil, rosemary oil, sage oil, sandalwood oil, celery oil, spike oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil and cypress oil and ambrettolide, ambroxan, α-amylcinnamaldehyde, anethol, anisaldehyde, anise alcohol, anisol, anthranilic acid methyl ester, acetophenone, benzyl acetone, benzaldehyde, benzoic acid ethyl ester, benzophenone, benzyl alcohol, benzyl acetate, benzyl benzoate, benzyl formate, benzyl valerianate, bomeol, bornyl acetate, boisambrene forte, α-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptine carboxylic acid methyl ester, heptaldehyde, hydroquinone dimethyl ether, hydroxycinnamaldehyde, hydroxycinnamyl alcohol, indol, irone, isoeugenol, isoeugenol methyl ether, isosafrole, jasmone, camphor, carvacrol, carvone, p-cresol methyl ether, cumarin, p-methoxyacetophenone, methyl n-amyl ketone, methyl anthranilic acid methyl ester, p-methyl acetophenone, methyl chavicol, p-methyl quinoline, methyl β-naphthyl ketone, methyl n-nonyl acetaldehyde, methyl n-nonyl ketone, muscone, β-naphthol ethyl ether, β-naphthol methyl ether, nerol, n-nonyl aldehyde, nonyl alcohol, n-octyl aldehyde, p-oxy-acetophenone, pentadecanolide, p-phenyl ethyl alcohol, phenyl acetic acid, pulegone, safrole, salicylic acid isoamyl ester, salicylic acid methyl ester, salicylic acid hexyl ester, salicylic acid cyclohexyl ester, santalol, sandelice, skatole, terpineol, thymene, thymol, troenan, γ-undelactone, vanillin, veratrum aldehyde, cinnmaldehyde, cinnamyl alcohol, cinnamic acid, cinnamic acid ethyl ester, cinnamic acid benzyl ester, diphenyl oxide, limonene, linalool, linalyl acetate and propionate, melusat, menthol, menthone, methyl n-heptenone, pinene, phenyl acetaldehyde, terpinyl acetate, citral, citronellal, and mixtures thereof.

In one aspect, the fragrance can have, for example, a musky scent, a pungent scent, a camphoraceous scent, an ethereal scent, a floral scent, a peppermint scent, or any combination thereof.

In one aspect, the fragrance can comprise methyl formate, methyl acetate, methyl butyrate, ethyl butyrate, isoamyl acetate, pentyl butyrate, pentyl pentanoate, octyl acetate, myrcene, geraniol, nerol, citral, citronellol, linalool, nerolidol, limonene, camphor, terpineol, α-ionone, thujone, benzaldehyde, eugenol, cinnamaldehyde, ethyl maltol, vanillin, anisole, anethole, estragole, thymol, indole, pyridine, furaneol, 1-hexanol, cis-3-hexenal, furfural, hexyl cinnamaldehyde, fructone, hexyl acetate, ethyl methyl phenyl glycidate, dihydrojasmone, oct-1-en-3-one, 2-acetyl-1-pyrroline, 6-acetyl-2,3,4,5-tetrahydropyridine, γ-decalactone, 7-nonalactone, Δ-octalone, jasmine lactone, massoia lactone, wine lactone, sotolon, grapefruit mercaptan, methanthiol, methyl phosphine, dimethyl phosphine, nerolin, 2,4,6-trichloroanisole, or any combination thereof.

In one aspect, the fragrance can comprise a linear terpene, a cyclic terpene, an aromatic compound, a lactone, a thiol, or any combination thereof.

Other art-known fragrances, or any fragrance commercially available from a fragrance supplier (for example, Firmenich, Givaudan, International Flavors and Fragrances (IFF), Symriseetc), or combinations of such fragrances, may also suitably be used in the CFTs, compositions, and methods disclosed herein.

In one aspect, the fragrance can be a fragrance precursor. “Fragrance precursor” refers to compounds which only release the actual fragrance following chemical conversion/separation, for example, when exposed to light or other environmental conditions, such as pH, temperature, etc. Compositions of this kind are often referred to as pro-fragrances.

In one aspect, the fragrance can be encapsulated, for example, in a microcapsule or a nanocapsule. The microcapsules and nanocapsules can be water-soluble or water-insoluble. In one aspect, all of the fragrance is encapsulated. Examples of encapsulated fragrances are described in, for example, U.S. Pat. Nos. 6,024,943, 6,056,949, 6,194,375, 6,458,754 and 8,426,353, and US 2011/0224127 A1, each of which is incorporated by reference in its entirety. In one aspect, the fragrance can be a free fragrance, a fragrance precursor, or an encapsulated fragrance, or any combination thereof.

In one aspect, the fragrance is present in the CFT in an amount from about 0.1% by weight to about 25.0% by weight, or from about 0.1% by weight to about 20% by weight, or from about 0.5% by weight to about 20% by weight, or from about 0.5% by weight to about 15% by weight, or from about 1% by weight to about 15% by weight, or from about 1% by weight to about 12% by weight, or from about 1.0% to about 5% by weight, or from about 3% by weight to about 12% by weight, based on the total weight of the CFT.

### Buffer System(s)

In embodiments, the CFT can include a buffer system. The buffer system is added to the CFT to buffer the effect of acids (i.e., acetic acid, resulting from sodium acetate of the water-soluble carrier), and the buffer system also has some chlorine scavenging properties. In one aspect, the CFT of the present disclosure comprises at least one buffer system. In one aspect, the buffer system(s) can be a solid buffer system, i.e., a solid (mixture) under standard conditions. In one aspect, the buffer system comprises a chlorine scavenger. In some embodiments, the CFT includes a solid buffer system selected from the group consisting of sodium hydrogen carbonate, sodium carbonate, disodium hydrogen phosphate, sodium glutamate, sodium aspartate, tris(hydroxymethyl)aminomethane (TRIS), and combinations thereof.

In one aspect, the buffer system has a pKa of at least about 5.75, or at least about 6.25, or at least about 6.75, and no more than about 12, or less than about 11.5, or about 11 or less, or about 10.5 or less.

In one aspect, the buffer system of the present disclosure is such that, when 1 g of the composition is dissolved in 50 g of deionized water, a pH of about 12, or of about 11.5, or of about 11, is not exceeded, and the buffer capacity of the resultant solution is at least about 2 mg HCl/g of the composition, or at least about 3 mg HCl/g of the composition, or at least about 4 mg HCl/g of the composition.

In one aspect, the buffer system can be present in an amount from about 0.1% by weight to about 10% by weight, or from about 0.5% to about 7.5% by weight, or from about 1% by weight to about 5% by weight, based on the total weight of the CFT.

### Rheology Modifier

In one aspect, the CFT of the present disclosure comprises at least one rheology modifier. In one aspect, the rheology modifier can be an inorganic rheology modifier and/or an organic rheology modifier.

In one aspect, the rheology modifier can be an inorganic rheology modifier such as, for example, silica. Suitable silicas include highly dispersed silicas, such as those having BET surface areas of more than about 50 m²/g, or more than about 100 m²/g, or from about 150 m²/g to about 250 m²/g, or from about 175 m²/g to about 225 m²/g. In one aspect, inorganic rheology modifier can be pyrogenic silica. In one aspect the rheology modifier is a highly dispersed silica having a BET surface area of between about 50 m²/g to about 225 m²/g.

In one aspect, the rheology modifier can be an organic rheology modifier. In one aspect, the organic rheology modifier can be cellulose. A suitable cellulose that can be employed is microfibrillated cellulose (MFC, nanocellulose).

In one aspect, the CFT of the present disclosure includes at least one inorganic silica or at least one organic silica. In one aspect, the CFT of the present disclosure includes at least one inorganic silica and at least one organic silica.

In one aspect, the CFT rheology modifier is present in amounts of from about 0.1% by weight to about 40% by weight, or from about 0.1% by weight to about 25% by weight, based on the total weight of the CFT.

### Emulsifying Substance(s)

In one aspect, the CFT of the present disclosure further comprises an emulsifying substance. In one aspect, the emulsifying substance can be a non-ionic surfactant, cationic surfactant, or anionic surfactant.

In one aspect, the emulsifying substance can include, for example, fatty alcohols, such as stearyl alcohol, fatty alcohol alkoxylates, such as fatty alcohol alkoxylates used as non-ionic surfactants, fatty alcohol and fatty alcohol ether sulfates and alkyl benzene sulfonates, in particular those that are also used as anionic surfactants, are suitable. Suitable fatty alcohol ethoxylates include C10-22 fatty alcohol ethoxylates having up to 50 EO, C12-18 alkyl ethers having 5-8, or 7 EO, and C16-18 alkyl ethers having up to 30 EO. Suitable fatty alcohol ether sulfates are the sulfates of the above-mentioned fatty alcohol ethers; suitable fatty alcohol sulfates are in particular C10-18 fatty alcohol sulfates and C12-16 fatty alcohol sulfates. Suitable alkyl benzene sulfonates are linear C10-13 alkyl benzene sulfonates.

In one aspect, the emulsifying substance can be fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines or combinations thereof.

In one aspect, the emulsifying substance can be present in an amount of from about 0.01% by weight to about 20% by weight, or from about 0.10% by weight to about 15% by weight, or from about 0.10% by weight to about 10% by weight, or from about 0.15% to about 2% by weight, or from about 0.15% to about 1% by weight, or from about 0.15 to about 0.5% by weight, or from about 0.15% to about 0.4% by weight, or from about 0.15% to about 0.35% by weight or from about 0.2% by weight to about 0.4% by weight, or from about 0.2% by weight to about 0.35% by weight of the CFT.

### Colorant(s)

In one aspect, the CFT of the present disclosure further comprises at least one colorant.

In one aspect, the CFT does not contain a colorant.

In one aspect, the CFT contains one or more colorants. In one aspect, the colorant can be a water-soluble polymer, water-insoluble polymer, a water-soluble dye, a water-insoluble dye, or a combination thereof.

In one aspect, the colorant(s) can be, for example, red, orange, yellow, blue, indigo, violet, or any combination thereof.

In one aspect, the colorant(s) can be Violet LS, Royal MC, Blue HP, Blue MC, Aquamarine, Green HMC, Bright Yellow, Yellow LP, Yellow BL, Brilliant Orange, Crimson, Red MX, Pink AL, Red BL, Red ST, Acid Blue 80, Acid Red 52, Acid Violet 48, Liquitint blue HP, Liquitint Bright Yellow Liquid, or a combination thereof.

In one aspect, the colorant(s) can be present in an amount of from about 0.0001% by weight to about 2.0% by weight, or from about 0.0001% by weight to about 1.5% by weight, or from about 0.0001% by weight to about 1.0% by weight, or from about 0.0001% by weight to about 0.5% by weight, or from about 0.001% by weight to about 0.3% by weight, or from about 0.001% by weight to about 0.1% by weight, or from about 0.001% by weight to about 0.05% by weight, or from about 0.001% by weight to about 0.025% by weight, or about 0.001% by weight, or about 0.002% by weight, or about 0.003% by weight, or about 0.0035% by weight of the composition.

### Bittering Agent(s)

In one aspect, the CFT of the present disclosure further comprises at least one bittering agent. In one aspect, the bittering agent can be denatonium benzoate.

### Solvent(s)

In one aspect, the CFT of the present disclosure further comprises at least one solvent. In one aspect, the solvent can be dipropylene glycol.

### Water

In one aspect, the CFT of the present disclosure further comprises free water. As used herein, “free water,” refers to water that is not bound in a salt contained in the composition.

PEG(s)

In one aspect, the CFT of the present disclosure does not contain polyethylene glycol (“PEG”), in the form of a coating, that is a solid at room temperature.

In one aspect, the CFT of the present disclosure contains less than about 1% by weight of PEG, in the form of a coating, that is solid at room temperature, by weight of the composition.

Additional Solid(s) and/or Filler(s)

In one aspect, the CFT of the present disclosure comprises additional ingredient(s) known to be employed in compositions for fabric treatment.

The additional ingredient(s) can be, for example, a bleaching agent, a bleach activator, an enzyme, a silicone oil, an anti-re-deposition agent, an optical brightener, a greying inhibitor, a shrink inhibitor, an anti-creasing agent, a color transfer inhibitor, an anti-microbial, a germicide, a dye transfer agent, a fungicide, an antioxidant, an anti-static agent, an ironing aid, a water proofing agent, an impregnation agent, a swelling agent, an anti-slip agent, a UV absorber, a corrosion inhibitor, or any combination thereof. In other aspects, the additive can be one or more viscosity-modifying agents (for example, silica, sodium CMC, and other agents well-known in the art to increase or decrease the viscosity of a liquid or liquid-containing suspension), one or more opacifying agents, and the like. In further aspects, the additional ingredient(s) can be scavengers, including, for example, chlorine scavengers.

The additional ingredient(s) can be, for example, a salt. Salts can include, but are not limited to, alkali metal salt, alkaline earth metal salt, and combinations thereof.

Alkali metal salts can be, for example, salts of lithium, sodium, potassium, rubidium, cesium, francium, or any combination thereof.

Useful alkali metal salts can be, for example, alkali metal fluorides, chlorides, bromides, iodides, sulfates, bisulfates, phosphates, monohydrogen phosphates, dihydrogen phosphates, carbonates, monohydrogen carbonates, acetates, citrates, lactates, pyruvates, silicates, ascorbates, or any combination thereof.

Alkali metal salts can include, for example, sodium fluoride, sodium chloride, sodium bromide, sodium iodide, sodium sulfate, sodium bisulfate, sodium phosphate, sodium monohydrogen phosphate, sodium dihydrogen phosphate, sodium carbonate, sodium hydrogen carbonate, sodium acetate, sodium citrate, sodium lactate, sodium tartrate, sodium silicate, sodium ascorbate, potassium fluoride, potassium chloride, potassium bromide, potassium iodide, potassium sulfate, potassium bisulfate, potassium phosphate, potassium monohydrogen phosphate, potassium dihydrogen phosphate, potassium carbonate, potassium monohydrogen carbonate, potassium acetate, potassium citrate, potassium lactate, potassium tartrate, potassium silicate, potassium ascorbate, or any combination thereof.

Alkaline earth metal salts include, for example, salts of beryllium, magnesium, calcium, strontium, barium, radium, or any combination thereof.

Alkaline earth metal salts can be, for example, alkaline metal fluorides, chlorides, bromides, iodides, sulfates, bisulfates, phosphates, monohydrogen phosphates, dihydrogen phosphates, carbonates, monohydrogen carbonates, acetates, citrates, lactates, pyruvates, silicates, ascorbates, or any combination thereof.

Alkaline earth metal salts can include, for example, magnesium fluoride, magnesium chloride, magnesium bromide, magnesium iodide, magnesium sulfate, magnesium phosphate, magnesium monohydrogen phosphate, magnesium dihydrogen phosphate, magnesium carbonate, magnesium monohydrogen carbonate, magnesium acetate, magnesium citrate, magnesium lactate, magnesium tartrate, magnesium silicate, magnesium ascorbate, calcium fluoride, calcium chloride, calcium bromide, calcium iodide, calcium sulfate, calcium phosphate, calcium monohydrogen phosphate, calcium dihydrogen phosphate, calcium carbonate, calcium monohydrogen carbonate, calcium acetate, calcium citrate, calcium lactate, calcium tartrate, calcium silicate, calcium ascorbate, or any combination thereof.

Salts can include, for example, inorganic salts, such as inorganic alkali metal salts and inorganic alkaline earth metal salts that do not contain carbon.

Salts can include, for example, organic salts, such as organic alkali metal salts and organic alkaline earth metal salt that contain carbon.

The additional ingredient(s) can be, for example, contained in the CFT in an amount ranging from about 0.00001% by weight to about 10% by weight, based on the weight of the CFT.

Some examples of additional ingredients can be, for example, U.S. powdered sugar 10×, polyvinylpyrrolidone K15, sodium sulfate, and sodium chloride.

The CFT can optionally contain further typical ingredients, for example those that improve the application-specific and/or aesthetic properties.

### Methods of Use

The CFTs of the present disclosure can be used to treat fabrics or textiles, for example, to provide malodor reduction/elimination, and to impart scent (i.e., apply fragrance to) to a fabric or textile.

In one aspect, the present disclosure provides a method of treating a fabric or a textile comprising combining or contacting the fabric or textile to be treated, with water and a CFT. The amount of CFT can be, for example, about 0.001 g to about 1 kg per treatment. The amount of the CFT can be, for example, about 0.01 g, about 0.1 g, about 1 g, about 2 g, about 3 g, about 4 g, about 5 g, about 6 g, about 7 g, about 8 g, about 9 g, about 10 g, about 25 g, about 50 g, about 100 g, about 200 g, about 300 g, about 400 g, about 500 g, about 600 g, about 700 g, about 800 g, or about 900 g per treatment.

The CFTs can be used in a top loading or front loading washer, in hot, warm, or cold water. The CFTs and laundry compositions can be used with a detergent in a wash cycle, or separately but in conjunction with a detergent (for example, in a separate wash or rinse cycle).

In one aspect, the disclosure provides a textile treated by a CFT, as disclosed herein.

In one aspect, the CFT can be added to an amount of water or wash liquor in which a textile is washed by hand.

The textile, after being treated, can be further processed, for example by drying, pressing, ironing, steaming, sewing, and the like.

### Exemplary CFT Formulations

Tables 1-5 below list exemplary CFT formulations (abbreviated as formula in the tables that follow) in accordance with the present disclosure. Note that within Tables 1-5 (and Table 6), the expression “HBCD” is used to describe highly-branched cyclic dextrin; and the expression “misc.” denotes optional ingredients/components that can be used. Each of the inventive formulations can be used in provided a melt body as follows: Heat sodium acetate trihydrate to a temperature of 70° C. and stir into water to form a first mixture. The remaining ingredients/components listed in Tables 1-5 can then be added to the first mixture to provide a second mixture (the second mixture is liquid). The CFTs (i.e., melt bodies) can be prepared by dropping the second mixture onto a cooling plate of which the temperature was adjusted to room temperature (i.e., about 23° C.). Each of the CFTs (i.e., melt bodies) that can be formed from formulations 1-26 provide fragrance and malodor reduction/elimination when used with laundered fabrics during the washing process.

TABLE 1

| | Wt % of | Wt % of | Wt % of | Wt % of | Wt % of |
|---|---|---|---|---|---|
| | Formula 1 | Formula 2 | Formula 3 | Formula 4 | Formula 5 |
| Component | (Inventive) | (Inventive) | (Inventive) | (Inventive) | (Inventive) |
| HBCD | 0.1 to 1.5 | 0.1 to 1 | 0.15 to 0.75 | 0.15 to 0.5 | 0.15 to 0.35 |
| Sodium acetate | 20 to 95 | 30 to 95 | 30 to 95 | 40 to 90 | 45 to 90 |
| trihydrate | | | | | |
| Fragrance | 0.1 to 20 | 0.1 to 20 | 1.0 to 15 | 1.0 to 1.5 | 3.0 to 12 |
| Buffer System | 0.1 to 10 | 0.25 to 8.5 | 0.5 to 7.5 | 0.75 to 6.0 | 1.0 to 5.0 |
| Misc. | q/s to 100 | q/s to 100 | q/s to 100 | q/s to 100 | q/s to 100 |

TABLE 2

| | Wt % of | Wt % of | Wt % of | Wt % of | Wt % of |
|---|---|---|---|---|---|
| | Formula 6 | Formula 7 | Formula 8 | Formula 9 | Formula 10 |
| Component | (Inventive) | (Inventive) | (Inventive) | (Inventive) | (Inventive) |
| HBCD | 0.1 to 1.5 | 0.1 to 1 | 0.15 to 0.75 | 0.15 to 0.5 | 0.15 to 0.35 |
| Sodium acetate | 20 to 95 | 30 to 95 | 30 to 95 | 40 to 90 | 45 to 90 |
| trihydrate | | | | | |
| Fragrance | 0.1 to 20 | 0.1 to 20 | 1.0 to 15 | 1.0 to 1.5 | 3.0 to 12 |
| Pyrogenic silica | 1.0 to 2.5 | 1.0 to 2.5 | 1.0 to 2.5 | 1.2 to 2.0 | 1.2 to 2.0 |
| Buffer System | 0.1 to 10 | 0.25 to 8.5 | 0.5 to 7.5 | 0.75 to 6.0 | 1.0 to 5.0 |
| Misc. | q/s to 100 | q/s to 100 | q/s to 100 | q/s to 100 | q/s to 100 |

TABLE 3

| | Wt % of | Wt % of | Wt % of | Wt % of | Wt % of |
|---|---|---|---|---|---|
| | Formula 11 | Formula 12 | Formula 13 | Formula 14 | Formula 15 |
| Component | (Inventive) | (Inventive) | (Inventive) | (Inventive) | (Inventive) |
| HBCD | 0.1 to 1.5 | 0.1 to 1 | 0.15 to 0.75 | 0.15 to 0.5 | 0.15 to 0.35 |
| Sodium acetate | 20 to 95 | 30 to 95 | 30 to 95 | 40 to 90 | 45 to 90 |
| trihydrate | | | | | |
| Fragrance | 0.1 to 20 | 0.1 to 20 | 1.0 to 15 | 1.0 to 1.5 | 3.0 to 12 |
| (Microfibrillated) | 1.0 to 25 | 1.0 to 20 | 0.1 to 18 | 0.01 to 15 | 0.1 to 10 |
| Cellulose | | | | | |
| TRIS | 0.1 to 10 | 0.25 to 8.5 | 0.5 to 7.5 | 0.75 to 6.0 | 1.0 to 5.0 |
| Misc. | q/s to 100 | q/s to 100 | q/s to 100 | q/s to 100 | q/s to 100 |

TABLE 4

| | Wt % of | Wt % of | Wt % of | Wt % of | Wt % of |
|---|---|---|---|---|---|
| | Formula 16 | Formula 17 | Formula 18 | Formula 19 | Formula 20 |
| Component | (Inventive) | (Inventive) | (Inventive) | (Inventive) | (Inventive) |
| HBCD | 0.1 to 1.5 | 0.1 to 1 | 0.15 to 0.75 | 0.15 to 0.5 | 0.15 to 0.35 |
| Sodium acetate | 20 to 95 | 30 to 95 | 30 to 95 | 40 to 90 | 45 to 90 |
| trihydrate | | | | | |
| Fragrance | 0.1 to 20 | 0.1 to 20 | 1.0 to 15 | 1.0 to 1.5 | 3.0 to 12 |
| Fatty alcohol | 0.1 to 10 | 0.1 to 5.0 | 0.2 to 5.0 | 0.2 to 3.0 | 0.5 to 2.0 |
| ethoxylate having | | | | | |
| from 5 to 50 EO | | | | | |
| TRIS | 0.1 to 10 | 0.25 to 8.5 | 0.5 to 7.5 | 0.75 to 6.0 | 1.0 to 5.0 |
| Misc. | q/s to 100 | q/s to 100 | q/s to 100 | q/s to 100 | q/s to 100 |

TABLE 5

| | Wt % of | Wt % of | Wt % of | Wt % of | Wt % of |
|---|---|---|---|---|---|
| | Formula 21 | Formula 22 | Formula 23 | Formula 24 | Formula 25 |
| Component | (Inventive) | (Inventive) | (Inventive) | (Inventive) | (Inventive) |
| HBCD | 0.1 to 1.5 | 0.1 to 1 | 0.15 to 0.75 | 0.15 to 0.5 | 0.15 to 0.35 |
| Sodium acetate | 20 to 95 | 30 to 95 | 30 to 95 | 40 to 90 | 45 to 90 |
| trihydrate | | | | | |
| Fragrance | 0.1 to 20 | 0.1 to 20 | 1.0 to 15 | 1.0 to 1.5 | 3.0 to 12 |
| Pyrogenic silica | 1.0 to 2.5 | 1.0 to 2.5 | 1.0 to 2.5 | 1.2 to 2.0 | 1.2 to 2.0 |
| (Microfibrillated) | 1.0 to 25 | 1.0 to 20 | 0.1 to 18 | 0.01 to 15 | 0.1 to 10 |
| Cellulose | | | | | |
| Fatty alcohol | 0.1 to 10 | 0.1 to 5.0 | 0.2 to 5.0 | 0.2 to 3.0 | 0.5 to 2.0 |
| ethoxylate having | | | | | |
| from 5 to 50 EO | | | | | |
| TRIS | 0.1 to 10 | 0.25 to 8.5 | 0.5 to 7.5 | 0.75 to 6.0 | 1.0 to 5.0 |
| Misc. | q/s to 100 | q/s to 100 | q/s to 100 | q/s to 100 | q/s to 100 |

Table 6 provides a formulation of a fabric fragrance composition which is not formed into a CFT (i.e., melt body). Formulation 26 is thus not of the invention.

TABLE 6

| | Wt % of |
|---|---|
| | Formula 26 |
| Component | (Non-Inventive) |
| HBCD | 20 to 90 |
| Fragrance | 0.1 to 20 |
| Pyrogenic silica | 1.0 to 2.5 |
| (Microfibrillated) | 1.0 to 25 |
| Cellulose | |
| Fatty alcohol | 0.1 to 10 |
| ethoxylate having | |
| from 5 to 50 EO | |
| TRIS | 0.1 to 10 |
| Misc. | q/s to 100 |

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A composition for fabric treatment comprising:
(a) from about 20 weight percent to about 95 weight percent of at least one water-soluble carrier selected from an aqueous salt, wherein the aqueous salts have a water vapor partial pressure at a particular temperature in a range of from 30° C. to 100° C. that corresponds to water partial pressure of a saturated solution of the salt;
(b) from about 0.05 weight percent to about 5.0 weight of a highly-branched cyclic dextrin;
(c) from about 0.1 weight percent to about 20 weight percent at least one fragrance; and
(d) from about 0.1 weight percent to about 10 weight percent of at least one buffer system, wherein the weight percent of (a)-(d) is based on a total weight of the composition.

2. The composition of claim 1, wherein the water-soluble carrier is selected from the group consisting of sodium acetate trihydrate (Na(CH₃COO)·3H₂O), sodium sulfate (Na₂SO₄·10H₂O), trisodium phosphate dodecahydrate (Na₃PO₄·12H₂O) and strontium chloride hexahydrate (SrCl₂·6H₂O), or water free sodium acetate.

3. The composition of claim 1, wherein the highly-branched cyclic dextrin has an average molecular weight of about 100 kilo Daltons to about 5000 kilo Daltons.

4. The composition of claim 1, wherein the highly-branched cyclic dextrin has an average molecular weight of about 500 kilo Daltons to about 3000 kilo Daltons.

5. The composition of claim 1, wherein the highly-branched cyclic dextrin is present in an amount from about 0.1 weight percent to about 1.5 weight percent.

6. The composition of claim 1, wherein the highly-branched cyclic dextrin is present in an amount from about 0.1 weight percent to about 1.0 weight percent.

7. The composition of claim 1, wherein the highly-branched cyclic dextrin is present in an amount from about 0.15 weight percent to about 0.75 weight percent.

8. The composition of claim 1, wherein the highly-branched cyclic dextrin is present in an amount from about 0.15 weight percent to about 0.5 weight percent.

9. The composition of claim 1, wherein the highly-branched cyclic dextrin is present in an amount from about 0.15 weight percent to about 0.35 weight percent.

10. The composition of claim 1, wherein the fragrance is an ester, an ether, an aldehyde, a ketone, an alcohol, a hydrocarbon, an essential oil, or a combination thereof.

11. The composition of claim 1, wherein the buffer system is a solid buffer system selected from the group consisting of sodium hydrogen carbonate, sodium carbonate, disodium hydrogen phosphate, sodium glutamate, sodium aspartate, tris(hydroxymethyl)aminomethane (TRIS), and combinations thereof.

12. The composition of claim 1, further comprising at least one rheology modifier selected from an inorganic rheology modifier, an organic rheology modifier and mixtures thereof, wherein the at least one rheology modifier is present in an amount of from about 0.1 percent by weight to about 25 percent by weight of the composition.

13. The composition of claim 12, wherein the inorganic rheology modifier is pyrogenic silica.

14. The composition of claim 12, wherein the organic rheology modifier is a microfibrillated cellulose.

15. The composition of claim 1, further comprising an emulsifying substance selected from the group consisting of fatty alcohols, fatty alcohol alkoxylates, fatty amide ethoxylates, fatty Page 2 of 3 alcohol sulfates, fatty alcohol ether sulfates, alkyl benzene sulfonates, allyl polyglycosides, fatty acid sorbitan esters, alkylamine oxides, alkyl betaines and combinations thereof.

16. The composition of claim 15, wherein the emulsifying substance is present in an amount of from about 0.10 percent by weight to about 10 percent by weight of the composition.

17. The composition of claim 1, wherein the composition comprises a plurality of individual particles in the form of melt bodies, wherein:
(a) the melt bodies have a particle size between about 0.5 mm and about 10 mm in any spatial direction,
(b) the melt bodies have a particle weight of between about 2 mg and about 150 mg,
(c) the melt bodies are solid at temperatures from about 20° C. to about 40° C.

18. The composition of claim 17 wherein the melt bodies are in the form of a pastille.

19. A method of controlling malodors of washed fabrics, the method comprising:
introducing a composition for fabric treatment into a washing apparatus that contains a at least one fabric, wherein the composition comprises (a) from about 20 weight percent to about 95 weight percent of at least one water-soluble carrier selected from an aqueous salt, wherein the aqueous salts have a water vapor partial pressure at a particular temperature in a range of from 30° C. to 100° C. that corresponds to water partial pressure of a saturated solution of the salt; (b) from about 0.05 weight percent to about 5.0 weight of a highly-branched cyclic dextrin, (c) from about 0.1 weight percent to about 20 weight percent at least one fragrance; and (d) from about 0.1 weight percent to about 10 weight percent of at least one buffer system, wherein the weight percent of (a)-(d) is based on a total weight of the composition; and
washing the at least one fabric in the presence of the composition.

20. The method of claim 19, wherein the composition is in the form of a plurality of pastilles.
